(19) United States
(12) Patent Application Publication
(10) Pub. No.: US 2017/0309967 A1
(43) Pub. Date: Oct. 26, 2017

(54) APPARATUS FOR INCREASING SAFETY WHEN USING BATTERY SYSTEMS

(71) Applicant: Robert Bosch GmbH, Stuttgart (DE)

(72) Inventor: Michael STEIL, Korntal-Muenchingen (DE)

(21) Appl. No.: 15/507,821

(22) PCT Filed: Aug. 5, 2015
(86) PCT No.: PCT/EP2015/068065

§ 371 Date: Mar. 1, 2017

(30) Foreign Application Priority Data
Sep. 2, 2014 (DE) 10 2014 217 525.9

(51) Int. Cl. H01M 10/42; H01M 10/613; H01M 10/0525

(52) U.S. Cl. CPC H01M 10/42; H01M 10/0525; H01M 10/613; H01M 2200/108; H01M 2200/20; H01M 2200/103

(57) ABSTRACT

The invention relates to a battery system (B), in particular a lithium-ion battery system, comprising at least one apparatus (V) for increasing safety when using the battery system (B), and comprising at least one discharge device (EV) suitable for electrical discharge of the battery system (B), wherein the at least one apparatus (V) is an apparatus for converting electrical energy from the battery system (B) into non-electrical energy, and the at least one apparatus (V) is connected to the discharge device (EV) at least in the case of a discharge of the battery system (B).

### BACKGROUND OF THE INVENTION

The present invention relates to a battery system.

Apparatuses for improving safety when using battery systems are known from the prior art, wherein the apparatus for improving safety when using a battery system is suitable for electrically short circuiting the battery system. By way of example, JP07201372A discloses a battery having a membrane that reacts to pressure, wherein the membrane deforms in dependence upon a pressure within the interior of the battery and an electrical contact can be produced between two terminals of the battery.

### SUMMARY OF THE INVENTION

The invention is based on a battery system, in particular a lithium ion battery system having at least one apparatus for improving safety when using the battery system and having at least one discharging apparatus suitable for electrically discharging the battery system.

The core of the invention resides in the fact that the at least one apparatus is an apparatus for converting electrical energy of the battery system into non-electrical energy and that the at least one apparatus is connected to the discharging apparatus at least in the event of discharging the battery system.

The fact that the at least one apparatus is an apparatus for converting electrical energy of the battery system into non-electrical energy and that the at least one apparatus is connected to the discharging apparatus at least in the event of discharging the battery system, leads to the advantage in accordance with the invention of discharging the battery system more quickly in dependence upon the fact that it is to be discharged or is discharged. The cause of the quicker discharge is that the discharge of the battery system is itself accelerated by means of converting electrical energy of the battery system into non-electrical energy.

The background of the invention is improving safety when handling a battery system, wherein in the event of a critical state of the battery system occurring, the battery system can be discharged. A critical state of the battery system is by way of example present if a gas occurs within the battery system and/or an irregular increase in a temperature and/or a pressure that prevail in the interior and/or exterior of the battery system occurs. With the electrical energy that is stored in the battery system there is a danger to life or objects that are located in the surrounding area of the battery system. The more quickly and more completely this electrical energy is converted and the battery system can be discharged, the smaller the danger to life or objects in the surrounding area of the battery system.

Moreover, a battery system is used in accordance with the invention in a vehicle, in particular in a motor vehicle. Furthermore, in particular a stationary use of the battery system is also possible.

In accordance with a further preferred embodiment of the invention, the at least one apparatus is connected to an energy conducting apparatus in an energy conductive manner. The energy conducting apparatus is suitable for discharging the non-electrical energy that is generated by means of the at least one apparatus into a spatial region outside the battery system.

The energy conductive connection of the at least one apparatus to an energy conducting apparatus, wherein the energy conducting apparatus is suitable for discharging the non-electrical energy that is generated by means of the at least one apparatus into a spatial region outside the battery system leads to the advantage in accordance with the invention that the non-electrical energy that is generated can be discharged into a spatial region outside the battery system in a reliable and controlled manner. Safety when handling a battery system is further improved by means of discharging the non-electrical energy into a spatial region outside the battery system. The background to this embodiment of the invention is that the more electrical energy is converted into non-electrical energy and can be discharged into a spatial region outside the battery system, the lower the probability of danger to life or objects that are located in the surrounding area of a damaged battery system. The non-electrical energy can be discharged by way of example into an energy storage device that is arranged outside the battery. The energy storage device that is arranged outside the battery can be in particular an apparatus for receiving mechanical energy, wherein the mechanical energy can be transferred to a turbine, a flywheel, an elastic body, a hydraulic system, a pneumatic system or can be transferred into a pressure container. The pressure container is suitable by way of example for receiving gases and in particular steam or condensed fluids. The pressure container by way of example can be under a pressure of 0 bar to 5 bar, preferably 0 bar to 2 bar or 3 bar to 5 bar in order to increase the boiling temperature and condensing temperature of the substances that are provided in the pressure container and consequently to cause an increased energy intake.

In accordance with a further advantageous embodiment of the invention, the at least one apparatus for converting the electrical energy into non-electrical energy is a mechanically-acting energy converter and/or a thermodynamically-acting energy converter and/or a chemically-acting energy converter.

The fact that the at least one apparatus for converting the electrical energy into non-electrical energy is a mechanically-acting energy converter and/or a thermodynamically-acting energy converter and/or a chemically-acting energy converter leads to the advantage in accordance with the invention of being able to determine the implementation of the conversion, by way of example the speed of the conversion and/or the efficiency of the conversion. It is possible to determine the implementation of the conversion since the mechanical, thermodynamic and chemical processes are known per se and can be adjusted in a controlled manner.

According to a next preferred embodiment of the invention, the mechanically-acting energy converter is an electrical drive that is operatively connected to a mechanically-operating consumer. The mechanically-operating consumer is in particular a flywheel, a turbine, an apparatus suitable for deforming an elastic body, a hydraulic system or a pneumatic system.

In accordance with a further advantageous embodiment of the invention, the mechanically-operating consumer and in particular the turbine are suitable for generating an air current, wherein the air current is in particular directed at at least one component of the battery system. The fact that the mechanically-operating consumer and in particular the turbine are suitable for generating an air current, wherein the air current is in particular directed at at least one component of the battery system, leads to the advantage in accordance with the invention that the at least one component of the battery system can be cooled. Safety when handling the battery system is improved by means of cooling the at least one component of the battery system. The background of improving safety is that in a relevant defective battery system heating components of the battery system can be the cause of the defective state and moreover can cause a further increase in damage to other components of the battery system and/or the battery system itself. The possibility of further damage to the battery system is altogether reduced by means of cooling the at least one component.

According to a further advantageous embodiment of the invention, the thermodynamically-operating energy converter is an electrothermally-operating apparatus, in particular an ohmic resistor or a Peltier element.

An electrothermally-acting apparatus is an apparatus that is suitable for converting electrical energy into thermal energy. The electrothermally-acting apparatus is operatively connected to an electrothermally-reactive substance, in particular a gaseous, fluid or solid electrothermally reactive substance.

The use of an ohmic resistor or a Peltier element leads to the advantage in accordance with the invention of being able to perform the thermodynamic conversion in a controlled and predetermined manner. The background to performing the conversion in a controlled and predetermined manner is that the physical and chemical and technical characteristics both of an ohmic resistor as well as a Peltier element are known. Moreover, neither refrigerants nor cooling means are required for the operation of both the ohmic resistor as well as the Peltier element.

According to a next preferred embodiment of the invention, the electrothermally-acting apparatus is suitable for condensing the fluid electrothermally-reactive substance in the event that it is a fluid electrothermally-reactive substance.

In accordance with a further advantageous embodiment of the invention, the electrothermally-acting apparatus is suitable for sublimation or for melting the solid electrothermally-reactive substance if the substance is a solid electrothermally reactive substance. The solid electrothermally reactive substance can be by way of example paraffin or a NaCl-based gel.

In accordance with a further advantageous embodiment of the invention, the thermodynamically-acting energy converter is suitable for cooling at least one component of the battery system. The fact that the thermodynamically-acting energy converter is suitable for cooling at least one component of the battery system leads to the advantage in accordance with the invention that safety is further improved when handling a defective battery system.

According to a next preferred embodiment of the invention, the chemically-acting energy converter is an electrochemical actuator, wherein the actuator is suitable for producing chemical reactions by means of electrical energy. The electrochemical actuator is operatively connected to a chemically endothermic reactive substance. Lithium chloride hydrate, lithium nitrate hydrate or sodium carbonate decahydrate are examples for a chemically endothermally reactive substance. For the case of converting electrical energy into non-electrical energy, the chemically endothermally reactive substance absorbs the non-electrical energy.

According to a further advantageous embodiment of the invention, the chemically-acting energy converter is suitable for cooling at least one component of the battery system. The fact that the chemically-acting energy converter is suitable for cooling at least one component of the battery system leads to the advantage in accordance with the invention that safety when handling a defective battery system is further improved.

In accordance with a further preferred embodiment of the invention, the at least one apparatus is coupled to an energy storage apparatus in an energy-transferring manner. The energy storage apparatus is suitable for receiving and storing non-electrical energy. The fact that the at least one apparatus is coupled to an energy storage apparatus in an energy-transferring manner leads to the advantage in accordance with the invention that the non-electrical energy that is generated can be stored in a controlled manner. Possible damage to the battery system or danger to life or objects that are located in the surrounding area of the battery system are avoided to the greatest possible extent by means of storing in a controlled manner the non-electrical energy that is generated.

In accordance with a further advantageous embodiment of the invention, the battery system comprises a control apparatus, wherein the control apparatus is suitable for controlling the at least one apparatus. The control apparatus is suitable for controlling the at least one apparatus in particular in dependence upon a state of the battery system and/or a consumer apparatus in which the battery system is used. A vehicle, in particular a motor vehicle, is an example of a consumer apparatus.

The fact that the battery system comprises a control apparatus, wherein the control apparatus is suitable for controlling the at least one apparatus in particular in dependence upon a state of a battery system and/or of a consumer apparatus in which the battery system is used leads to the advantage in accordance with the invention that the at least one apparatus can be controlled in dependence upon the state of the battery system and/or the consumer apparatus can be controlled when required. An unnecessary conversion of electrical energy into non-electrical energy is consequently avoided. Moreover, the portion of the electrical energy that is to be converted can be determined. The portion of electrical energy that is to be converted can be determined in dependence upon the extent of the damage to the battery system.

### BRIEF DESCRIPTION OF THE DRAWINGS

The invention is explained hereinunder with reference to exemplary embodiments from which further novel features are evident but to which the invention is not limited. The exemplary embodiments are illustrated in the figures.

In the figures:

FIG. 1 illustrates schematically a battery system in accordance with the invention having at least one apparatus for improving safety when using the battery system and having at least one discharging apparatus in accordance with a first embodiment,

FIG. 2 illustrates schematically a battery system in accordance with the invention having at least one apparatus for improving safety when using the battery system and having at least one discharging apparatus in accordance with a second embodiment,

FIG. 3 illustrates schematically a battery system in accordance with the invention having at least one apparatus for improving safety when using the battery system and having at least one discharging apparatus in accordance with a third embodiment.

### DETAILED DESCRIPTION

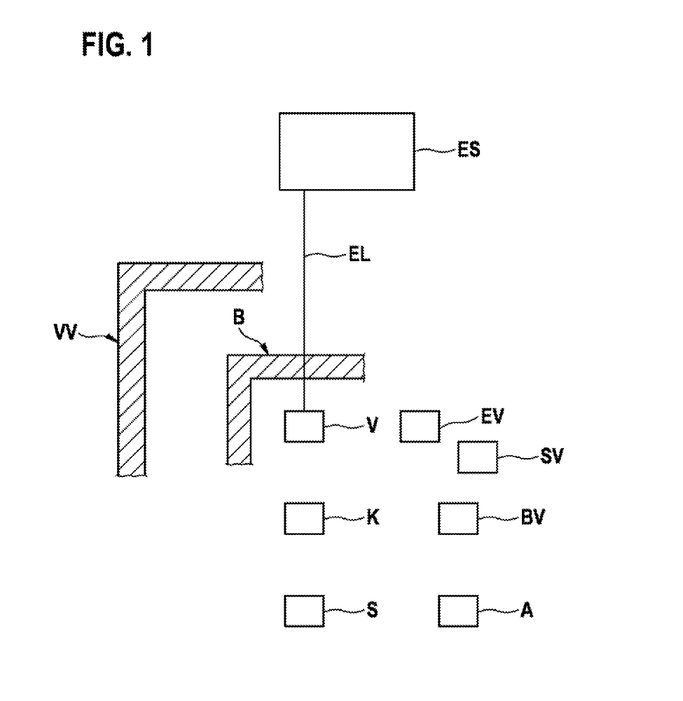

FIG. 1 illustrates schematically a battery system in accordance with the invention, in particular a lithium ion battery system having at least one apparatus that is suitable for improving safety when using the battery system, and having at least one discharging apparatus that is suitable for electrically discharging the battery system in accordance with a first embodiment. B refers to the battery system. The battery system B can comprise a battery apparatus BV, the battery apparatus BV represents the actual electrochemical energy storage device of the battery system B. The battery apparatus BV can be a battery module including at least one battery cell or one battery cell itself. The inner wall of the battery apparatus BV can comprise by way of example surface structures, wherein the surface structures facilitate a transfer of heat. For this purpose, the surface structure can be wave-shaped or lamellar or can be embodied in accordance with a fractal geometry.

VV refers to a consumer apparatus. The battery system B is used by way of example within the consumer apparatus VV. The consumer apparatus VV can be by way of example a vehicle, in particular a motor vehicle.

EV refers to a discharging apparatus, wherein the discharging apparatus EV is suitable for electrically discharging the battery system B. V refers to at least one apparatus for improving safety when using the battery system B. The at least one apparatus V is suitable for converting electrical energy of the battery system B into non-electrical energy. EL refers to an energy conducting apparatus. The energy conducting apparatus EL is suitable for discharging the non-electrical energy that is generated by means of the at least one apparatus V into a spatial region outside the battery system B. ES refers to an energy storage apparatus. The energy storage apparatus ES is located preferably outside the battery system B and is suitable for receiving and storing the non-electrical energy that is transferred in particular by way of the energy conducting apparatus EL.

SV refers to a control apparatus. The control apparatus SV is suitable for controlling the at least one apparatus V. The at least one apparatus V can be controlled using the control apparatus SV and the procedure of converting electrical energy of the battery system B can be started. The converting procedure can be started in dependence upon the state of the battery system B and by way of example the state of the battery apparatus BV. At least one sensor S can be used to determine the state of the battery system B or the battery apparatus BV. The sensor S is preferably suitable for determining electrical variables of the battery system B or the battery apparatus BV, for example a current that flows through a line of the battery system B or the battery apparatus BV or a voltage that prevails between two poles of the battery system B or the battery apparatus BV. The at least one sensor S is by way of example also suitable for ascertaining and determining a pressure and/or a temperature that prevails in the interior of the battery system B or the battery apparatus BV or the occurrence of gas forming or fluid escaping within the battery system B or the battery apparatus BV. The sensor S can be in particular a pressure sensor or a temperature sensor. In order to determine an occurrence of gas forming or fluid escaping within the battery apparatus BV the sensor S can be in particular a gas sensor or a fluid sensor, both the occurrence of gas forming as well as fluid escaping can also be determined by means of a pressure sensor. The background of using a pressure sensor to acquire confirmation is that a change of pressure within the battery apparatus BV can accompany an occurrence of gas forming or fluid escaping within the battery apparatus BV. The information that is obtained by the at least one sensor S in a sensor technical manner, said information regarding physical state variables of the battery system B or the battery apparatus BV can be processed by way of example by means of an evaluating apparatus A and in particular a comparison of threshold values can be performed. The conversion of electrical energy into non-electrical energy can be started in dependence upon the threshold comparison by means of the control apparatus SV. Moreover, in particular the portion of the electrical energy that is to be converted can be adjusted using the control apparatus SV. K refers to a further component of the battery system B in which the further component K can be a further, other battery apparatus or a further other control apparatus.

Moreover, the at least one apparatus V can be controlled externally, by way of example in the event of a safety critical state of the consumer apparatus VV. The external control can be performed automatically by means of a safety apparatus of the consumer apparatus VV or by way of example by people using an input apparatus; the input apparatus can be arranged by way of example within and/or outside the consumer apparatus VV. In the event of the consumer apparatus VV being a vehicle and in particular a motor vehicle, the safety apparatus can be in particular an airbag control device or a radar sensor. Moreover, the control apparatus SV can be suitable for transferring information regarding the fact that the apparatus V has been controlled to a safety apparatus outside the battery system B. The safety apparatus outside the battery system B can be by way of example an HMI interface in a vehicle or a warning apparatus, by way of example a horn device, a warning light or a headlight on a vehicle.

In the event that the apparatus V is a thermodynamically-acting or chemically-acting energy converter, wherein the thermodynamically-acting energy converter is an electrothermally-acting apparatus and the chemically-acting energy converter is an electrochemical actuator that is operatively connected to a chemically endothermally reactive substance, the electrothermally-acting apparatus or the chemically endothermally reactive substance or a container in which the chemically endothermally reactive substance is arranged comprises a surface in the form of a sphere, an icosahedron or a dodecahedron. Moreover, the surface of the container can comprise a wave-shaped or lamellar-shaped structure or a fractal surface.

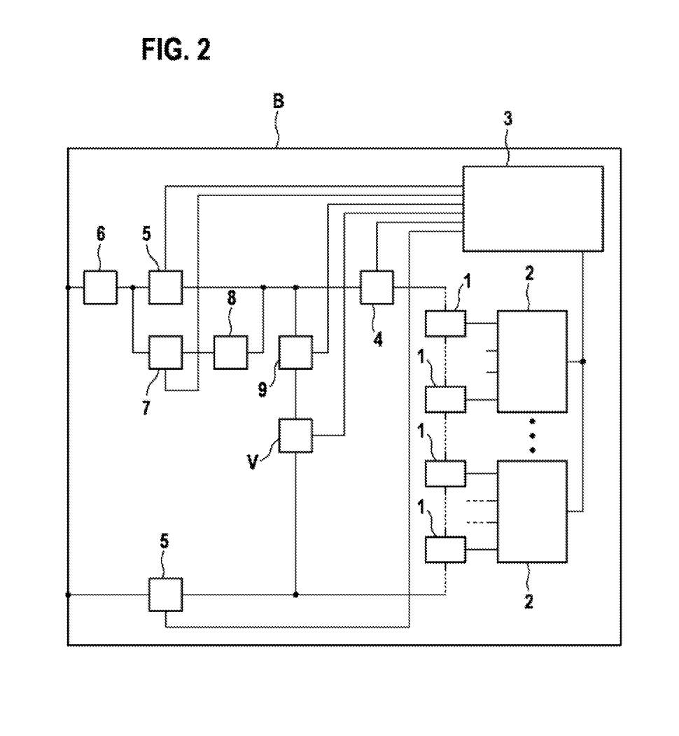

FIG. 2 illustrates schematically a battery system in accordance with the invention in accordance with a second alternative embodiment, in particular a lithium ion battery system, having at least one apparatus suitable for improving safety when using the battery system and having at least one discharging apparatus suitable for electrically discharging the battery system. B refers to the battery system. The battery system B comprises at least one battery cell 1. A plurality of battery cells 1 is monitored by at least one module controller 2 with regard to physical variables. The physical variables can be a current that flows through a line of the at least one battery cell 1, or a voltage that prevails between two poles of the at least one battery cell 1. Moreover, the at least one module controller 2 is suitable for measuring the temperature within and/or outside the at least one battery cell 1. Furthermore, the module controller 2 is suitable for balancing an electrical state of charge between at least two battery cells 1. At least one module controller 2 is connected by means of a BUS system, in particular a CAN—controller area network—to a battery control device 3. Moreover, a further current sensor 4 can be connected to the battery control device 3. The further current sensor 4 can be a Hall sensor or a shunt sensor. The current that is determined by means of the module controller 2 can be tested and checked for plausibility with reference to an independent measurement by means of the further current sensor 4, in particular the Hall sensor or the shunt sensor.

The battery control device 3 is suitable for controlling a main contactor 5 and a precharging contactor 7. A precharging resistor 8 is provided in a precharging branch. The precharging contactor 7 and the precharging resistor 8 are used to charge in a current-limited manner an intermediate circuit capacity (not illustrated) outside the battery system B.

Moreover, a fuse 6 is provided in a main current circuit of the battery system.

Moreover, a switch 9 and at least one apparatus V for converting electrical energy of the battery system B into non-electrical energy are provided. The switch 9 is used to operate the at least one apparatus V. The switch 9 can be in particular a pyrotechnical lock-up switch. The switch 9 can in particular be controlled by the battery control device 3. The switch 9 can be controlled by way of example in dependence upon a state of the battery system B or a consumer apparatus in which the battery system B is used. If the consumer apparatus is by way of example a vehicle, preferably a motor vehicle, the switch 9 can thus be controlled in dependence upon a vehicle accident that is detected. Data from vehicle systems, by way of example data from radar measurements or from an ESP system of the vehicle, can be used to detect a vehicle accident.

It is preferred that prior to actuating the switch 9 at least one main contactor 5 is opened in order to consequently prevent a possible current flow out of the battery system B. In addition or alternatively, the apparatus V and a switch for operating the apparatus V can be arranged outside the battery system B. In particular, the apparatus V can also convert electrical energy of the battery system B into non-electrical energy without controlling the switch 9 and by way of example in dependence upon a pressure or a temperature that prevails in the interior or exterior of the battery system, preferably then if the apparatus V is a thermodynamically-acting or chemically-acting energy converter. In the event that the apparatus is a thermodynamically-acting or chemically-acting energy converter, wherein the thermodynamically-acting energy converter is an electrothermally-acting apparatus and the chemically-acting energy converter is an electrochemical actuator that is operatively connected to a chemically endothermally reactive substance, the electrothermally-acting apparatus or the chemically endothermally reactive substance, or a container in which the chemically endothermally reactive substance is arranged comprises a surface in the form of a sphere, an icosahedron or a dodecahedron. Moreover, the surface of the container can comprise a wave-shaped or lamellar-shaped structure or a fractal surface.

Furthermore, the chemically endothermally reactive substances, in particular if these substances are lithium chloride hydrate, lithium nitrate hydrate or sodium carbonate hydrate, can be arranged in at least one carrier apparatus. The at least one carrier apparatus is preferably arranged between at least one battery cell 1 and at least one other battery cell 1. The at least one carrier apparatus can be embodied by way of example from silicone foams or polyurethane foam and preferably can comprise a honeycombed structure. Heat that occurs can be absorbed by means of the arrangement of the chemically endothermally reactive substances in the at least one carrier apparatus and the propagation of said heat from the at least one battery cell 1 to the at least one other battery cell 1 can be prevented to the greatest possible extent. It is preferred that the chemically endothermally reactive substances are arranged together with aluminum hydroxide in the at least one carrier apparatus. During regular operation, the carrier apparatus prevents the propagation of heat that possibly occurs in at least one battery cell 1 to another battery cell 1. In the event of the electrical energy being converted into non-electrical energy, the non-electrical energy can be stored within the carrier apparatus.

The carrier apparatus can be arranged by way of example within a cell housing of the battery cell 1. If the battery system B comprises at least one battery module, wherein the at least one battery module comprises at least one battery cell 1, the carrier apparatus can preferably be arranged in a housing of the at least one battery module. If the battery system B comprises at least one battery pack, wherein the at least one battery pack comprises at least one battery module, the carrier apparatus can preferably be arranged in a housing of the at least one battery pack. If the battery system B comprises at least one electronic apparatus, the carrier apparatus can preferably be arranged in a housing of the at least one electronic apparatus.

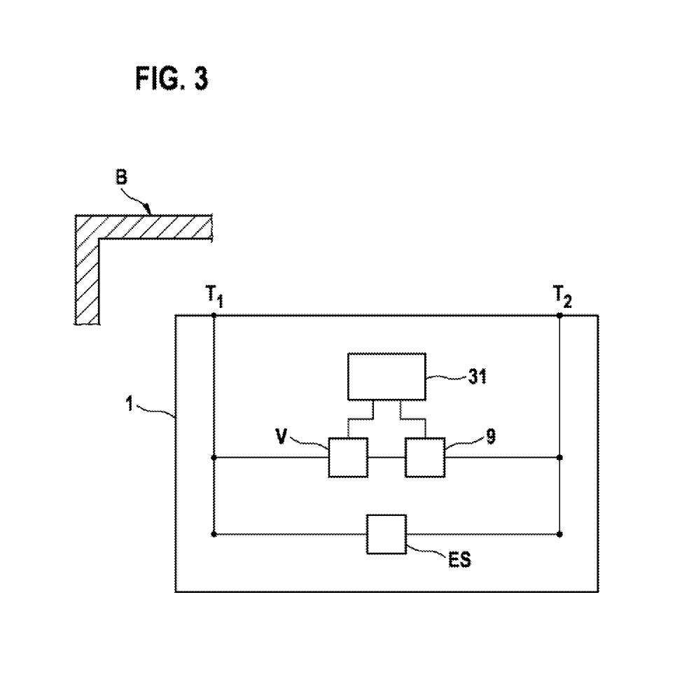

FIG. 3 illustrates schematically a battery system in accordance with the invention, in particular a lithium ion battery system, having at least one apparatus suitable for improving safety when using the battery system, and having at least one discharging apparatus suitable for electrically discharging the battery system, in accordance with a third alternative embodiment. B refers to the battery system. In accordance with this embodiment, the apparatus V and the switch 9 are arranged within the at least one battery cell 1. T1 and T2 refers to terminals of the battery cell 1. A control unit that is referred to as 31 and likewise arranged within the at least one battery cell 1 is provided so as to control the switch 9. The non-electrical energy that is generated by the apparatus V can be transferred to an energy storage device ES and can be stored by said energy storage device. In particular, the apparatus V can also convert electrical energy of the battery system B into non-electrical energy without controlling the switch 9 and by way of example in dependence upon a rising pressure, preferably then if the apparatus V is a thermodynamically-acting or chemically-acting energy converter. If the energy converter is a chemically-acting energy converter, wherein the chemically-acting energy converter is an actuator that is operatively connected to a chemically endothermally reactive substance and wherein the chemically endothermally reactive substances are in particular lithium chloride hydrate, lithium nitrate hydrate or sodium carbonate hydrate, said chemically endothermally reactive substances can be arranged in particular together with aluminum hydroxide on a boric acid wafer or within a mesh matrix. By virtue of this arrangement, the chemically endothermally reactive substances can perform an energy conversion in the most efficient manner possible.

1. A battery system (B) comprising:
at least one apparatus (V) for improving safety when using the battery system (B); and at least one discharging apparatus (EV), suitable for electrically discharging the battery system (B) wherein the at least one apparatus (V) is an apparatus for converting electrical energy of the battery system (B) into non-electrical energy and that the at least one apparatus (V) is connected to the discharging apparatus (EV) at least in the case of discharging the battery system (B).

2. The battery system (B) as claimed in claim 1, wherein the at least one apparatus (V) is connected to an energy conducting apparatus (EL) in an energy conductive manner, wherein the energy conducting apparatus (EL) is suitable for discharging the non-electrical energy that is generated by means of the at least one apparatus (V) into a spatial region outside the battery system (B).

3. The battery system (B) as claimed in claim 1, wherein the at least one apparatus (V) for converting the electrical energy into non-electrical energy is a mechanically-acting energy converter and/or a thermodynamically-acting energy converter and/or a chemically-acting energy converter.

4. The battery system (B) as claimed in claim 3, wherein the mechanically-acting energy converter is an electrical drive that is operatively connected to a mechanically-acting consumer, wherein the mechanically-acting consumer is one selected from the group consisting of a flywheel, a turbine, an apparatus suitable for deforming an elastic body, a hydraulic system, and a pneumatic system.

5. The battery system (B) as claimed in claim 4, wherein the turbine is suitable for generating an air flow, wherein the air flow is directed towards at least one component (K) of the battery system (B).

6. The battery system (B) as claimed in claim 3, wherein the thermodynamically-acting energy converter is an electrothermally-acting apparatus that is operatively connected to an electrothermally reactive substance.

7. The battery system (B) as claimed in claim 6, wherein the electrothermally-acting apparatus in the event that a fluid electrothermally reactive substance is involved is suitable for condensing the fluid electrothermally reactive substance.

8. The battery system (B) as claimed in claim 6, wherein the electrothermally-acting apparatus for the case that it is a solid electrothermally reactive substance is suitable for sublimation or for melting the solid electrothermally reactive substance.

9. The battery system (B) as claimed in claim 6, wherein the thermodynamically-acting energy converter is suitable for cooling at least one component (K) of the battery system (B).

10. The battery system (B) as claimed in claim 3, wherein the chemically-acting energy converter is an electrochemical actuator suitable for producing a chemical reaction by means of electrical energy, wherein the electrochemical actuator is operatively connected to a chemically endothermally reactive substance.

11. The battery system (B) as claimed in claim 10, wherein the chemically-acting energy converter is suitable for cooling at least one component (K) of the battery system (B).

12. The battery system (B) as claimed in claim 1, wherein an energy storage apparatus (ES) is coupled in an energy-transferring manner to the at least one apparatus (V), wherein the energy storage apparatus (ES) is suitable for receiving and storing non-electrical energy.

13. The battery system (B) as claimed in claim 1, wherein the battery system (B) comprises a control apparatus (SV).

14. The battery system (B) as claimed in claim 1, further comprising a vehicle.
